(19) United States
(12) Patent Application Publication
(10) Pub. No.: US 2003/0016325 A1
(43) Pub. Date: Jan. 23, 2003

(54) Liquid crystal display device

(75) Inventors: Takayuki Konno, Tokyo (JP); Masayoshi Suzuki, Tokyo (JP); Toshiya Ishii, Tokyo (JP); Kiyomi Kawada, Tokyo (JP); Hiroaki Matsuyama, Tokyo (JP); Yoshihiko Hirai, Tokyo (JP)

Correspondence Address: McGinn & Gibb, PLLC, 8321 Old Courthouse Road, Suite 200, Vienna, VA, 22182-3817, US

(73) Assignee: NEC Corporation, Tokyo (JP)

(21) Appl. No.: 10/198,092

(22) Filed: Jul. 19, 2002

(30) Foreign Application Priority Data
Jul. 23, 2001 (JP) 221085/2001

(51) Int. Cl. G02F 1/1335

(52) U.S. Cl. 349/117

(57) ABSTRACT

A polarizer and a ¼ wavelength plate are bonded to each of first and second substrates of a liquid crystal panel that includes a liquid crystal layer having a bend alignment such that an angle between an optical axis of the ¼ wavelength plate and a transmission axis of the polarizer is made 45° relative to each other to make circularly polarized lights outputted respectively from the ¼ wavelength plate and the polarizer each have a polarity opposite each other. In this case, since a light inputted to a liquid crystal display device is converted into a circularly polarized light before entering a liquid crystal layer, the maximum value of an intensity of the light exited from the device becomes constant regardless of the orientation of the optical axis of the liquid crystal layer 101. As described above, the optical axis of the liquid crystal layer is desirably made parallel to a horizontal direction to improve stability of the liquid crystal layer having a bend alignment, and further, the transmission axes of the first and second polarizers are freely made only just maintaining forcible positional relationship therebetween which makes the transmission axes of the first and second polarizers orthogonal to each other, thereby allowing a viewing angle along horizontal and vertical directions to increase.

### BACKGROUND OF THE INVENTION

1. Field of the Invention

The present invention relates to a large size and high-resolution liquid crystal display device having wide viewing angle and high speed response properties and used to display moving images.

2. Description of the Prior Art

Conventionally, in a twisted nematic (hereinafter abbreviated to “TN”) type liquid crystal display device which is widely used, a “white” display state gradually becomes a “black” display state by changing a direction of an orientation vector of a liquid crystal molecule to a direction of an electric field in accordance with a voltage applied to the molecule. Note that the “white” display state is a state in which the orientation direction of a liquid crystal molecule becomes parallel to the surface of a substrate when no voltage is applied to the molecule.

However, in the case of the TN type liquid crystal display device, there is a problem in that a viewing angle is small owing to the peculiar behaviors of a liquid crystal molecule when a voltage is applied thereto. The viewing angle becomes further smaller with respect to a direction in which the liquid crystal molecule rises when a gray scale image is displayed.

To solve such problems, a method of improving viewing angle properties of a liquid crystal display device is proposed in publications such as JP 04-261522 A, JP 06-043461

A and JP 10-333180 A.

According to those methods, a liquid crystal cell, to which homeotropic alignment is applied, is prepared and is interposed between two polarizers so that transmission axes thereof are orthogonal to each other, and a common electrode having apertures is used to generate an oblique electric field in each pixel. At least two liquid crystal domains are produced in each pixel by the oblique electric field, thereby improving viewing angle properties.

According to a method disclosed in JP 04-261522 A, an orientation of liquid crystal molecule at the time of a voltage applied thereto is controlled to achieve high contrast of images to be displayed.

Also, according to a method disclosed in JP 06-043461 A, an optical compensation plate is optionally used to improve viewing angle properties observed when a black display is performed.

Furthermore, according to a method disclosed in JP 06-043461 A, a liquid crystal cell to which TN alignment is applied as well as a liquid crystal cell to which homeotropic alignment is applied has at least two domains partitioned by the oblique electric field to improve the viewing angle properties.

Furthermore, according to a method disclosed in JP 10-333180 A, in order to protect the effect of an oblique electric field generated by a common electrode having apertures therein against electric fields from a thin film transistor, a gate line, and a drain line g, the thin film transistor, the gate line and the drain line are disposed under a display electrode.

In JP 10-020323 A, the following method is described. That is, in a liquid crystal display device in which at least two kinds of minute regions coexist, an aperture is formed in one substrate and a second electrode is formed in the aperture. Then, a voltage is applied to the second electrode to generate an oblique electric field to partition liquid crystal molecules into a plurality of liquid crystal molecules having orientations different from each other in a pixel, thereby achieving a wide viewing angle. This method is mainly employed in a liquid crystal cell to which the TN alignment is applied.

In JP 05-113561 A, the following technique is described. That is, a optically negative birefringence compensation plate for canceling an angle dependence of birefringence of liquid crystal molecule observed when no voltage is applied to the molecule and an optically positive ¼ wavelength plate and an optically negative ¼ wavelength plate, both being provided to keep brightness of images to be displayed, are employed in a vertical alignment type liquid crystal display device to increase a viewing angle.

JP 2947350 B discloses the following technique. That is, protrusions or slits to partition an electrode are formed on each of upper and lower substrates to partition vertically aligned liquid crystal molecules when a voltage is applied to the molecules, and the corresponding liquid crystal panel is constructed by making at least one of the substrates have the protrusion thereon.

In JP 05-505247 A discloses an in-plane switching (IPS) mode liquid crystal display device in which two electrodes are provided on one substrate and a voltage is applied between the two electrodes to generate an electric field in a direction parallel to the substrate to thereby rotate a liquid crystal molecule in parallel with the substrate. According to the IPS mode liquid crystal display device, the longitudinal axis of the liquid crystal molecule never rises with respect to the substrate when a voltage is applied to the molecule. Accordingly, the device thus constructed is able to make a change of birefringence of liquid crystal when viewing the device from a different direction small and increase a viewing angle.

Journal of Applied Physics, Vol.45, No.12 (1974) 5466 and JP 10-186351 A disclose the following technique. That is, first, liquid crystal molecules having a positive dielectric anisotropy are previously homeotropic-aligned and an electric field parallel to the substrate is generated, and then, the molecules are oriented in parallel with the substrate, which operation is accomplished by adding some functions to the above-described IPS mode. According to this method, the homeotropic-aligned liquid crystal molecules are partitioned into at least two regions each including liquid crystal molecules having different orientations from each other depending on the direction of the electric field. As a result, a liquid crystal display device achieves a wide viewing angle.

JP 10-186330 proposes the following technique. That is, a square-shaped wall is formed using a photosensitive material on a substrate to constitute a pixel as a basic unit and liquid crystal molecules having a negative dielectric anisotropy are divided within each pixel, and then tilted by applying a voltage to the divided molecules.

However, the above-described techniques including the conventional TN type liquid crystal display device all have unfavorable electrical properties, i.e., low response speed. A liquid crystal display device using nematic liquid crystal generally has low response speed. Response time between gray scales amounts to about 100 nm prevents the liquid crystal display device from displaying moving images at a high rate.

Therefore, a liquid crystal display device capable of providing a wide viewing angle and high-speed response has been required.

For example, an optically compensated birefringence (hereinafter abbreviated as “OCB”) mode liquid crystal display device exhibiting a high speed response while having a wide viewing angle is disclosed in publications such as Y. Yamaguchi, et al., SID′93, Digest, pp.277-280 and JP 07-084254 A. A liquid crystal cell used in the OCN type liquid crystal display device has liquid crystal molecules having a bend alignment and therefore, is also called a n(pi) cell. For example, JP 55-142316 A also discloses a technique in which the n cell exhibits a high-speed response.

FIG. 1 shows one example of a fundamental configuration of an OCB-mode liquid crystal display device.

The liquid crystal display device shown in FIG. 1 comprises two glass substrates 802, 803 disposed to make rubbing directions thereof become parallel to each other, a liquid crystal layer 801 in a bend alignment state interposed between the glass substrates 802, 803, two birefringence compensation plates 804, 805 interposing the two glass substrates 802, 803 therebetween from outside and two polarizers 806, 807 interposing the birefringence compensation plates 804, 805 therebetween from outside.

The birefringence compensation plates 804, 805 employs a discotic liquid crystal therein which is optically negative and whose orientation of principal axis changes within a liquid crystal layer.

The bend alignment always exhibits self-compensation capability in a rubbing direction and optically symmetric characteristic owing to its structure.

In the case of a liquid crystal display device, in which pixels are divided into sub-pixels consisting of primary colors, one sub-pixel has a vertically elongated shape such that a ratio of a longitudinal length of pixel to a transversal length thereof is about 3:1. In such a case, taking into account the stability of the bend alignment, the rubbing direction is advantageously made to coincide with a direction parallel to the short side of a pixel, i.e., a horizontal direction thereof.

Likewise, taking into account viewing angle properties required for a display, the rubbing direction to enable self-compensation is made to coincide with a horizontal direction.

A change of an orientation of a liquid crystal molecule aligned with the bend alignment becomes maximum in a plane parallel to the direction of an optical axis, i.e., an orientation direction of the liquid crystal molecule at an interface between the molecule and an alignment layer, and perpendicular to a substrate. Therefore, in the case where the liquid crystal layer is sandwiched by two polarizers whose transmission axes are orthogonal to each other, birefringence becomes maximum when the direction of the optical axis is made to have an angle of 45° with respect to the transmission axis of the polarizer. When the rubbing direction is securely made parallel to a horizontal direction, the transmission axes of the two polarizers 806 and 807 each are forced to have an angle of 45° with respect to the transmission axis of the polarizer.

A driving method for then OCB-mode liquid crystal display device can be classified into two methods, i.e., a normally black LCD to perform black display at a low voltage and a normally white LCD to perform black display at a high voltage. In the case of the normally black LCD in which birefringence to be compensated is large, a light leakage due to wavelength dispersion is large resulting in difficulty in obtaining sufficient contrast.

Therefore, JA 08-327822 A discloses a technique to solve the above-stated problem by employing two negative birefringence compensation plates 804 and 805 shown in FIG. 1 to realize a normally black LCD. In more detail, almost all liquid crystal molecules except for molecules near the interface between a liquid crystal layer and an alignment layer are vertically aligned at a high voltage. When residual birefringences in both interfaces are compensated by the two negative birefringence compensation plates 804, 805, a wide viewing angle is achieved.

However, in the conventional OCB-mode liquid crystal display device, viewing angle favorably becomes wide in a direction having an angle of 45° with respect to the optical axis, i.e., the direction of the transmission axis of the polarizer.

Generally, a liquid crystal display device including an OCB-mode display device, which utilizes birefringence, has preferable viewing angle properties in a direction parallel to the direction of the transmission axis of the polarizer owing to viewing angle dependence of the polarizer itself.

Therefore, it is desirable to make the transmission axes of two polarizers aligned with a direction that can be optionally selected by a user. However, in a current construction of liquid crystal display device, to move the transmission axes of two polarizers, the optical axis of the liquid crystal layer has to simultaneously be moved. Furthermore, in terms of stability of liquid crystal molecules having a bend alignment, moving the optical axis of the liquid crystal layer from a horizontal direction is not preferable.

Thus, alignment of the transmission axis of the polarizer is limited to a large extent when employing the conventional OCB-mode liquid crystal display device, thereby preventing sufficient utilization of its wide viewing angle properties.

Moreover, in the case of the conventional OCB-mode liquid crystal display device, liquid crystal molecules have to be aligned in a desired direction with high accuracy to achieve high brightness and high contrast. In other words, since brightness and contrast are degraded by displacement of an orientation direction of a liquid crystal molecule, allowance applied to process steps for manufacturing a liquid crystal display device is unfavorably small.

### SUMMARY OF THE INVENTION

An object of the present invention is to provide a liquid crystal display device in which significant deterioration of an optical characteristic can be prevented even when an orientation direction of a liquid crystal is slightly displaced, advantageously producing allowance for manufacturing tolerances applicable to manufacture of a liquid crystal display device.

In order to achieve the above-mentioned object, there is provided a liquid crystal display device comprising a first substrate, a second substrate, a liquid crystal layer sandwiched between the first substrate and the second substrate and having a bend alignment, a first ¼ wavelength plate disposed on a surface of the first substrate, the surface being positioned opposite the liquid crystal layer, a second ¼ wavelength plate disposed on a surface of the second substrate, the surface being positioned opposite the liquid crystal layer, at least one first polarizer disposed on a surface of the first ¼ wavelength plate, the surface being positioned opposite the liquid crystal layer, and at least one second polarizer disposed on a surface of the second ¼ wavelength plate, the surface being positioned opposite the liquid crystal layer.

According to the present invention, converting a light inputted to a liquid crystal layer to a circularly polarized light makes it possible to make the transmission axis of the polarizer aligned with a desired direction, allowing a liquid crystal display device to most preferably display images regardless of angles from which the images are viewed.

For instance, the liquid crystal display device according to the present invention can be constructed such that circularly polarized lights outputted respectively from the first ¼ wavelength plate and the first polarizer are opposite each other, circularly polarized lights outputted respectively from the second ¼ wavelength plate and the second polarizer are opposite each other,an angle between an optical axis of the first ¼ wavelength plate and a transmission axis of the first polarizer is made 45° relative to each other, and an angle between an optical axis of the second ¼ wavelength plate and a transmission axis of the second polarizer is made 45° relative to each other.

When the first ¼ wavelength plate is disposed such that the optical axis thereof is made having an angle of 45° relative to the transmission axis of the first polarizer, a linearly polarized light having passed through the first polarizer is converted into a circularly polarized light by the first ¼ wavelength plate. In a case where a liquid crystal display device is viewed from a side thereof on which a light incident, when the optical axis of the first ¼ wavelength plate is made to have an angle of 45° rightward relative to the transmission axis of the first polarizer, the linearly polarized light exiting from the first ¼ wavelength plate becomes a right-handed circularly polarized light and when the optical axis thereof is made to have an angle of 45° to leftward relative to the same, the linearly polarized light exiting therefrom becomes a left-handed circularly polarized light.

For example, assume that the optical axis of the second ¼ wavelength plate to be disposed on a side of the device from which a light exits is made parallel to the optical axis of the first ¼ wavelength plate and the transmission axis of the second polarizer is made orthogonal to the transmission axis of the first polarizer. In a case where a total retardation of birefringence media laminated between the two ¼ wavelength plates is Π, the right-handed circularly polarized light exits from the second ¼ wavelength plate as a left-handed circularly polarized light and is converted into a linearly polarized light orthogonal to the linearly polarized light inputted to the first ¼ wavelength plate by the second ¼ wavelength plate. In this case, an intensity of the light transmitted through the two ¼ wavelength plates becomes maximum. Thus, regardless of the orientation of the optical axis of the liquid crystal layer, or even when initial orientation directions near interfaces between the liquid crystal layer and the first second substrate and between the liquid crystal layer and the second substrate are displaced from each other, a maximum intensity of the light transmitted through the two ¼ wavelength plates is obtained. In a case where the total retardation thereof is zero, the right-handed circularly polarized light exits as it is, and is converted into a linearly polarized light parallel to the linearly polarized light inputted to the first ¼ wavelength plate by the second ¼ wavelength plate. In this case, an intensity of transmitted light becomes zero.

When the above-described construction of liquid crystal display device is applied to an actual utilization of liquid crystal display device, the optical axis of the liquid crystal layer is made parallel to a horizontal direction to improve stability of the liquid crystal layer having a bend alignment, and further, the transmission axes of the first and second polarizers are freely made only just maintaining forcible positional relationship therebetween which makes the transmission axes of the first and second polarizers orthogonal to each other, thereby allowing a viewing angle along horizontal and vertical directions to increase.

Thus, according to the liquid crystal display device of the present invention, only adding the two ¼ wavelength plates to the configuration of the conventional liquid crystal display device makes it possible to improve viewing angle properties desired by a user without significantly modifying process steps for manufacturing a liquid crystal display device.

Note that the ¼ wavelength plate is a kind of optically active uniaxial medium and therefore, the birefringence of the ¼ wavelength plate itself likely affects operation for compensating for the birefringence of the liquid crystal layer. Accordingly, preferably, one of a pair of ¼ wavelength plates is made to have optically positive activity and the other is made to have optically negative activity to compensate for the birefringence of the ¼ wavelength plate.

Alternatively, when one of the ¼ wavelength plates is optically positive, an optically negative birefringence compensation plate for compensating for the birefringence of the ¼ wavelength plate in addition to the birefringence of the liquid crystal layer may be added to the liquid crystal display device.

To address a problem found in the ¼ wavelength plate having wavelength dispersion, a norbornene system transparent heat-resistant resin having a small wavelength dispersion (produced by JSR Corporation, product name: ARTON) is used as a material constituting a ¼ wavelength plate, or a laminate structure having a ¼ wavelength plate and a ½ wavelength plate is employed in a liquid crystal display device, thereby making a liquid crystal display device operate at wider frequencies.

In this case, an optical compensation layer may be added to the liquid crystal display device such that the optical compensation layer compensates for the birefringences of the liquid crystal layer, the ¼ wavelength plate and the ½ wavelength plate with the aid of a combination of materials whose constitutive elements are optically negative to thereby make a total retardation of the device become zero. Furthermore, an optically biaxial compensation plate may be employed in the liquid crystal display device instead of a part or an entire of a plurality of the above-described plates, which perform the above-stated functions.

Furthermore, preferably, the liquid crystal display device according to the present invention further comprises a first birefringence compensation plate disposed between the first substrate and the first ¼ wavelength plate and a second birefringence compensation plate disposed between the second substrate and the second ¼ wavelength plate, in which both the first and second birefringence compensation plates each are comprised of optically negative elements and have a principal axis within a layer of each of the first and second birefringence compensation plates changing, and birefringence of the liquid crystal layer is compensated by the first and second birefringence compensation plates.

Additionally, preferably, the liquid crystal display device according to the present invention further comprises a birefringence compensation plate disposed between the second substrate and the second ¼ wavelength plate, in which the birefringence compensation plate is comprised of optically negative elements and have a principal axis within a layer of the birefringence compensation plate changing, and birefringence of the liquid crystal layer is compensated by the birefringence compensation plate.

Moreover, preferably, the liquid crystal display device according to the present invention further comprises one of an optically positive uniaxial birefringence compensation plate and an optically positive biaxial birefringence compensation plate disposed between the second substrate and the second ¼ wavelength plate, in which birefringence of the liquid crystal layer is compensated by corresponding one of the uniaxial birefringence compensation plate and the biaxial birefringence compensation plate.

In addition, preferably, the liquid crystal display device according to the present invention further has on the first substrate a plurality of scanning signal electrodes, a plurality of video signal electrodes intersecting the scanning signal electrodes in matrix, a plurality of thin film transistors formed at positions corresponding to respective intersection points of the scanning signal electrodes and the video signal electrodes, a pixel having one of areas surrounded by the scanning signal electrodes and the video signal electrodes and a pixel electrode connected with each of the plurality of thin film transistors corresponding to the pixel, and further has on the second substrate a common electrode for supplying a reference potential to a plurality of the pixels.

Moreover, preferably, the liquid crystal display device according to the present invention further has on the first substrate an interlayer insulating film for separating the pixel electrode from the scanning signal electrodes, the video signal electrodes and the thin film transistors.

Furthermore, preferably, the liquid crystal display device according to the present invention further has on the first substrate a color filter layer formed on the scanning signal electrodes, the video signal electrodes and the thin film transistors, in which the pixel electrode is separated from the scanning signal electrodes, the video signal electrodes and the thin film transistors via the color filter layer.

Preferably, the liquid crystal display device according to the present invention is further constructed such that the liquid crystal layer contains an ultraviolet polymerization monomer therein to stabilize, the liquid crystal layer having a bend alignment, and for instance, the ultraviolet polymerization monomer is a liquid crystalline diacrylate monomer.

Preferably, the liquid crystal display device according to the present invention is further constructed such that an orientation of the liquid crystal near interfaces between the first and second substrates and the liquid crystal layer is substantially parallel to a short side of the pixel.

### BRIEF DESCRIPTION OF THE DRAWINGS

FIG. 1 is an exploded configuration view of a conventional liquid crystal display device;

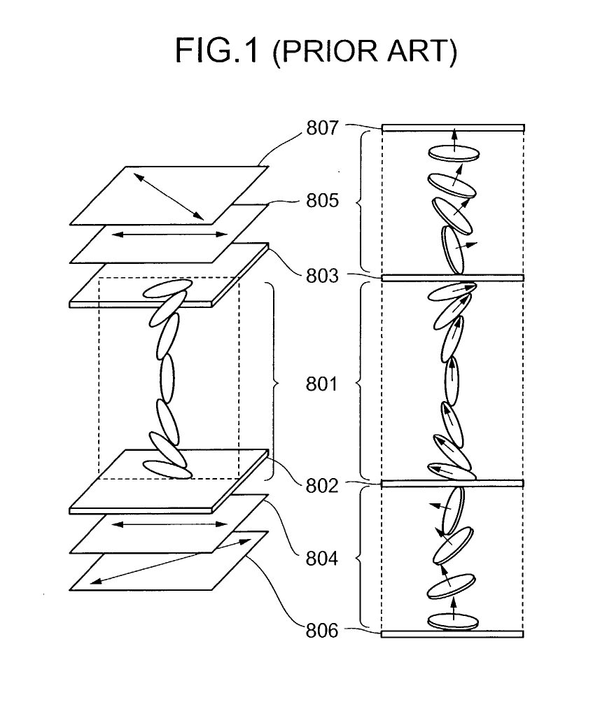

FIG. 2 is an exploded configuration view of a liquid crystal display device according to a first embodiment of the present invention;

FIG. 3 is an exploded configuration view of a liquid crystal display device according to a second embodiment of the present invention;

FIG. 4 is an exploded configuration view of a liquid crystal display device according to a third embodiment of the present invention;

FIG. 5 is an exploded configuration view of a liquid crystal display device according to a fourth embodiment of the present invention;

FIG. 6 is a plan view of one pixel in a liquid crystal display device according to a fifth embodiment of the present invention;

FIG. 7 is a sectional view of the liquid crystal display device according to the fifth embodiment of the present invention; and

FIG. 8 is a sectional view of a liquid crystal display device according to a sixth embodiment of the present invention.

### DETAILED DESCRIPTION OF THE PREFERRED EMBODIMENTS

Preferred embodiments of the present invention will be described in detail below.

### First Embodiment

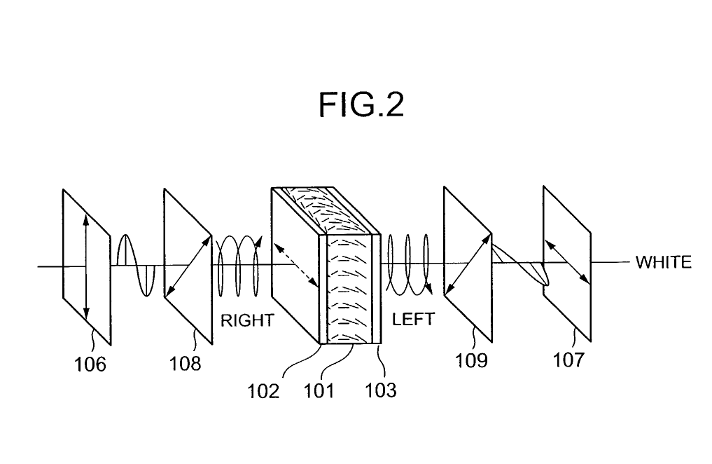

FIG. 2 is an exploded configuration view of a liquid crystal display device according to a first embodiment of the present invention. The liquid crystal display device of the embodiment includes a first substrate 102, a second substrate 103, a liquid crystal layer 101 sandwiched between the first and second substrates 102, 103 and having a bend alignment, a first ¼ wavelength plate 108 disposed outside the first substrate 102, a first polarizer 106 disposed outside the first ¼ wavelength plate 108, a second ¼ wavelength plate 109 disposed outside the second substrate 103 and a second polarizer 107 disposed outside the second ¼ wavelength plate 109.

The liquid crystal display device according to the embodiment operates as follows.

An incident light having passed through the first polarizer 106 is converted into a linearly polarized light by the first polarizer 106. The optical axis of the first ¼ wavelength plate 108 is made to have an angle of 45° rightward relative to the transmission axis of the light polarizer as viewed from a position where the incident light enters. Thus, the incident light is converted from the linearly polarized light into a right-handed circularly polarized light.

When a retardation of the liquid crystal layer 101 having a bend alignment is equal to n, the right-handed circularly polarized light thus inputted to the liquid crystal layer 101 exits therefrom as a left-handed circularly polarized light.

After that, the left-handed circularly polarized light is converted into a linearly polarized light orthogonal to the linearly polarized light inputted to the first ¼ wavelength plate by the second ¼ wavelength plate 109 whose optical axis is oriented parallel to that of the first ¼ wavelength plate 108. In other words, the linearly polarized light inputted to the first ¼ wavelength plate is optically rotated by 90°.

Thus, the linearly polarized light exiting from the second ¼ wavelength plate 109 is made parallel to the transmission axis of the second polarizer 107, making an intensity of the light maximum.

Therefore, in the liquid crystal display device according to the embodiment, regardless of the orientation of the optical axis of the liquid crystal layer 101, the maximum value of an intensity of a light exited from the device becomes constant.

Also, since the liquid crystal molecules of the liquid crystal layer 101 having a bend alignment, even when a time period necessary for the molecules to respond to an on/off voltage applied thereto is added to a time period necessary for the molecules to convert the light inputted thereto, an entire time period necessary for the liquid crystal display device to respond to a supplied signal becomes at most 7 ms, enabling the liquid crystal display device to respond in very short time period.

### Second Embodiment

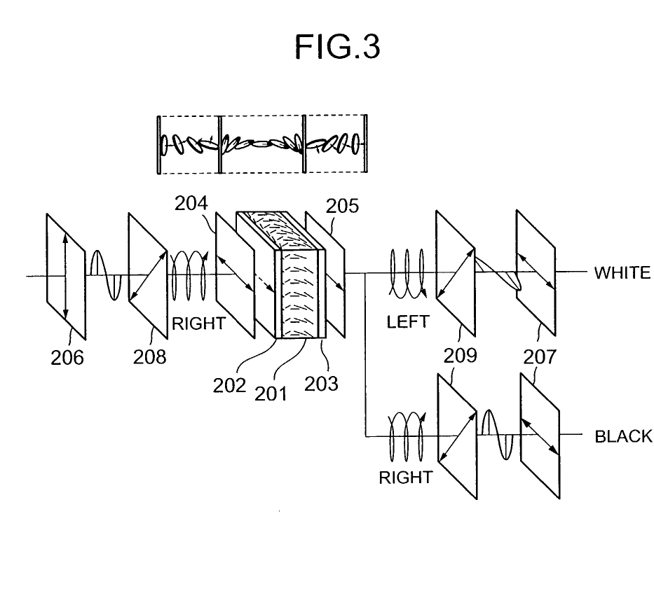

FIG. 3 is an exploded configuration view of a liquid crystal display device according to a second embodiment of the present invention. The liquid crystal display device according to the embodiment includes a first substrate 202, a second substrate 203, a liquid crystal layer 201 sandwiched between the first and second substrates 202, 203 and having a bend alignment, a first birefringence compensation plate 204 disposed outside the first substrate 202, a first ¼ wavelength plate 208 disposed outside the first birefringence compensation plate 204, a first polarizer 206 disposed outside the first ¼ wavelength plate 208, a second birefringence compensation plate 205 disposed outside the second substrate 203, a second ¼ wavelength plate 209 disposed outside the second birefringence compensation plate 205 and a second polarizer 207 disposed outside the second ¼ wavelength plate 209.

Both elements constituting the first and second birefringence compensation plates 204, 205 are optically negative. In the first and second birefringence compensation plates 204, 205, discotic liquid crystal molecules are tilted within a liquid crystal layer. The first and second birefringence compensation plates 204, 205 compensate for the birefringence of the liquid crystal layer 201 in a black display state.

The liquid crystal display device of the embodiment is different from the liquid crystal display device of the first embodiment in that the former includes the first and second birefringence compensation plates 204 and 205.

The liquid crystal display device of the embodiment operates as follows.

An incident light having passed through the first polarizer 206 is converted into a linearly polarized light by the first polarizer 206. The optical axis of the first ¼ wavelength plate 208 is made to have an angle of 45° rightward relative to the transmission axis of the light polarizer as viewed from a position where the incident light enters. Thus, the incident light is converted from the linearly polarized light into a right-handed circularly polarized light.

In a white display state, the birefringence of the liquid crystal layer 201 having a bend alignment is compensated by the first and second birefringence compensation plates 204, 205, both of which use a discotic liquid crystal, making the retardation of the liquid crystal layer 201 become n. Thus, the right-handed circularly polarized light thus inputted to the first birefringence compensation plate 204 exits from the second birefringence compensation plate 205 as a left-handed circularly polarized light. In this case, the left-handed circularly polarized light is converted into a linearly polarized light orthogonal to the linearly polarized light inputted to the first ¼ wavelength plate 208 by the second ¼ wavelength plate 209. In other words, the linearly polarized light inputted to the first ¼ wavelength plate is optically rotated by 90°.

Thus, the linearly polarized light exiting from the second ¼ wavelength plate 209 is made parallel to the transmission axis of the second polarizer 207, making an intensity of the light maximum.

In a black display state, the birefringence of the liquid crystal layer 201 having a bend alignment is compensated by the first and second birefringence compensation plates 204, 205, both of which utilize a discotic liquid crystal, thereby making the retardation of the liquid crystal layer 201 becomes zero. Accordingly, the right-handed circularly polarized light inputted to the first birefringence compensation plate 204 exits from the second birefringence compensation plate 205 as it is. After that, the light thus exiting therefrom is converted into the same linearly polarized light as the linearly polarized light inputted to the first ¼ wavelength plate by the second ¼ wavelength plate 209 whose optical axis is made parallel to that of the first ¼ wavelength plate 208.

Thus, the linearly polarized light exiting from the second ¼ wavelength plate 209 is blocked by the second polarizer 207 whose transmission axis is orthogonal to that of the first polarizer 206.

As described above, a normally white LCD is realized. A light transmittance in a white display state always becomes constant independently of the direction of the optical axis of the liquid crystal layer 201.

Furthermore, since a black display state is optically compensated, an image with high visibility is obtained regardless of an angle at which the image is viewed, thereby realizing a display device with a very wide viewing angle.

Moreover, the liquid crystal layer 201 having a bend alignment enables the liquid crystal display device to respond to an inputted signal in very short time period compared with that observed by employing the other type liquid crystal display device.

### Third Embodiment

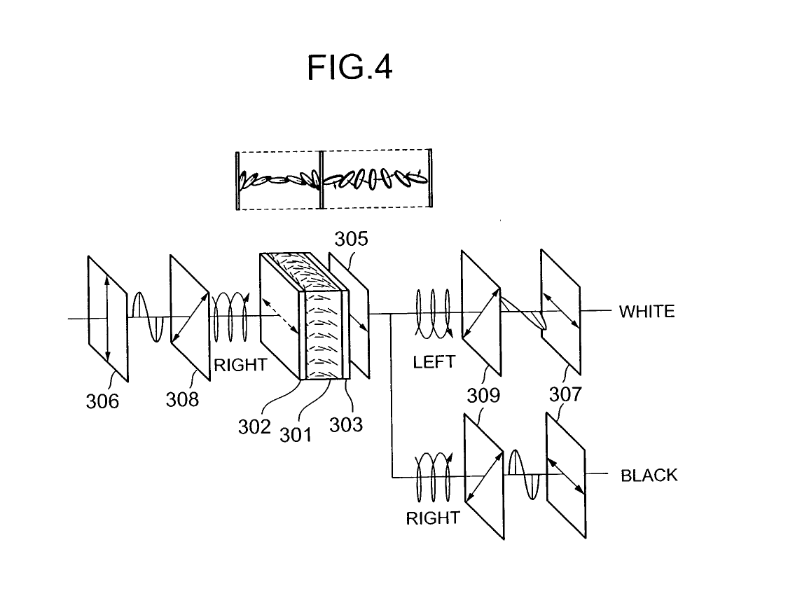

FIG. 4 is an exploded configuration view of a liquid crystal display device according to a third embodiment of the present invention. The liquid crystal display device according to the embodiment includes a first substrate 302, a second substrate 303, a liquid crystal layer 301 sandwiched between the first and second substrates 302, 303 and having a bend alignment, a first ¼ wavelength plate 308 disposed outside the first substrate 302, a first polarizer 306 disposed outside the first ¼ wavelength plate 308, a birefringence compensation plate 305 disposed outside the second substrate 303, a second ¼ wavelength plate 309 disposed outside the second substrate 303 and a second polarizer 307 disposed outside the second ¼ wavelength plate 309.

In the birefringence compensation plate 305, discotic liquid crystal molecules are tilted within a liquid crystal layer. In addition, the second ¼ wavelength plate 309 has an optical axis substantially parallel to that of the first ¼ wavelength plate 308 and has a negative optical activity.

The liquid crystal display device of the embodiment is different from the liquid crystal display device of the first embodiment regarding the following two points. First, the birefringence of the liquid crystal layer 301 in a black display state is compensated by the birefringence compensation plate 305. Secondly, entire birefringence between the first and second polarizers 306, 307 in a black display state is made zero using the second ¼ wavelength plate 309.

The liquid crystal display device of the embodiment operates as follows.

An incident light having passed through the first polarizer 306 is converted into a linearly polarized light by the first polarizer 306.

The optical axis of the first ¼ wavelength plate 308 is tilted to have an angle of 45° rightward relative to the transmission axis of the polarizer as viewed from a position where the incident light enters. In addition, the liquid crystal display device is designed such that the second ¼ wavelength plate 309 compensates the first ¼ wavelength plate 308 for the birefringence, canceling out the birefringence of the two ¼ wavelength plates.

In a white display state, the birefringence of the liquid crystal layer 301 having a bend alignment is compensated by the birefringence compensation plate 305 that is optically negative and employs a discotic liquid crystal, making the retardation of the liquid crystal layer 301 become n. Accordingly, the right-handed circularly polarized light inputted to the first substrate 302 exits as a left-handed circularly polarized light from the birefringence compensation plate 305. In this case, the left-handed circularly polarized light is converted into a linearly polarized light orthogonal to the linearly polarized light inputted to the first ¼ wavelength plate 308 by the second ¼ wavelength plate 309. In other words, the linearly polarized light inputted to the first ¼ wavelength plate is optically rotated by 90°.

Thus, the linearly polarized light exiting from the second ¼ wavelength plate 309 is made parallel to the transmission axis of the second polarizer 307, making an intensity of the light maximum.

In a black display state, the birefringence of the liquid crystal layer 301 having a bend alignment is compensated by the birefringence compensation plate 305, which utilizes a discotic liquid crystal, thereby making the retardation of the liquid crystal layer 301 becomes zero. Accordingly, the right-handed circularly polarized light inputted to the first substrate 302 exits from the birefringence compensation plate 305 as it is. After that, the light thus exiting therefrom is converted into the same linearly polarized light as the linearly polarized light inputted to the first ¼ wavelength plate by the second ¼ wavelength plate 309 whose optical axis is made parallel to that of the first ¼ wavelength plate 308.

Thus, the linearly polarized light exiting from the second ¼ wavelength plate 309 is blocked by the second polarizer 307 whose transmission axis is orthogonal to that of the first polarizer 306.

As described above, a normally white LCD is realized. A light transmittance in white and black display states always becomes constant independently of the direction of the optical axis of the liquid crystal layer 301.

Furthermore, according to the liquid crystal display device of the embodiment, since a black display state is compensated in the same manner as that employed in the second embodiment, an image with high visibility is obtained regardless of an angle at which the image is viewed, thereby realizing a display device with a very wide viewing angle.

Moreover, the liquid crystal layer 301 having a bend alignment enables the liquid crystal display device to respond to an inputted signal in very short time period compared with that observed by employing the other type liquid crystal display device.

### Fourth Embodiment

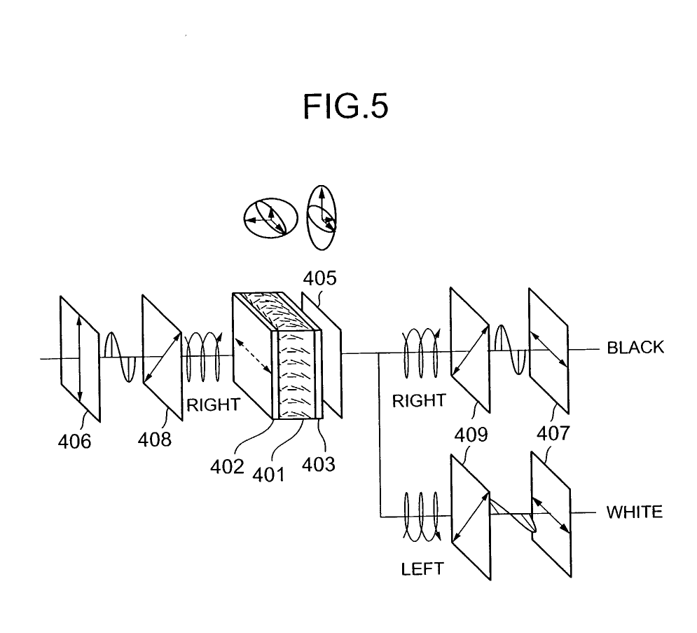

FIG. 5 is an exploded configuration view of a liquid crystal display device according to a fourth embodiment of the present invention. The liquid crystal display device according to the embodiment includes a first substrate 402, a second substrate 403, a liquid crystal layer 401 sandwiched between the first and second substrates 402, 403 and having a bend alignment, a first ¼ wavelength plate 408 disposed outside the first substrate 402, a first polarizer 406 disposed outside the first ¼ wavelength plate 408, an optically positive biaxial birefringence compensation plate 405 disposed outside the second substrate 403, a second ¼ wavelength plate 409 disposed outside the biaxial birefringence compensation plate 405, and a second polarizer 407 disposed outside the second ¼ wavelength plate 409.

The optically positive biaxial birefringence compensation plate 405 is an optically positive birefringence compensation plate and compensates for the birefringence of the liquid crystal layer 401 in a black display state.

The liquid crystal display device of the embodiment is different from the liquid crystal display device of the first embodiment in that the former includes the optically positive biaxial birefringence compensation plate 405.

The liquid crystal display device of the embodiment operates as follows.

An incident light having passed through the first polarizer 406 is converted into a linearly polarized light by the first polarizer 406. The optical axis of the first ¼ wavelength plate 408 is made to have an angle of 45° rightward relative to the transmission axis of the polarizer as viewed from a position where the incident light enters. Thus, the incident light is converted from a linearly polarized light into a right-handed circularly polarized light.

In a black display state, the birefringence of the liquid crystal layer 401 having a bend alignment is compensated by the optically positive biaxial birefringence compensation plate 405, making the retardation of the liquid crystal layer 401 become zero. Thus, the right-handed circularly polarized light inputted to the substrate 402 exits from the optically positive biaxial birefringence compensation plate 405 as it is. After that, the light exiting therefrom is converted into the same linearly polarized light as the incident linearly polarized light inputted to the first ¼ wavelength plate 408 by the second ¼ wavelength plate 409 whose optical axis is parallel to that of the first ¼ wavelength plate 408.

The linearly polarized light thus exiting from the second ¼ wavelength plate 409 is blocked by the second polarizer 407 whose transmission axis is orthogonal to that of the first polarizer 406.

In a white display state, the birefringence of the liquid crystal layer 401 having a bend alignment is compensated by the biaxial birefringence compensation plate 405, making the retardation become Π. Accordingly, the right-handed circularly polarized light inputted to the substrate 402 exits from the optically positive biaxial birefringence compensation plate 405 as a left-handed circularly polarized light. In this case, the left-handed circularly polarized light is converted into a linearly polarized light that is orthogonal to the linearly polarized light inputted to the first ¼ wavelength plate 408 by the second ¼ wavelength plate 409. In other words, the linearly polarized light inputted to the first ¼ wavelength plate 408 is optically rotated by 90°.

As a result, since the linearly polarized light exiting from the second ¼ wavelength plate 409 is parallel to the transmission axis of the second polarizer 407, an intensity of the light becomes a maximum.

As described above, a normally white LCD is realized and light transmittance in white and black display states always becomes constant while being independent of the direction of the optical axis of the liquid crystal layer 401.

In the embodiment, the liquid crystal layer 401 is compensated assuming the liquid crystal layer 401 is a single biaxial birefringence medium. Since it is difficult for the single positive biaxial birefringence compensation plate 405 to compensate for the birefringence of the liquid crystal layer 401 in a situation where a high voltage is applied to the liquid crystal layer to vertically rise up liquid molecules included therein, the embodiment employs a normally black LCD.

Furthermore, according to the liquid crystal display device of the embodiment, since a black display state is compensated in the same manner as that employed in the second embodiment, an image with high visibility is obtained regardless of an angle at which the image is viewed, thereby realizing a display device with a very wide viewing angle.

Moreover, the liquid crystal layer 401 having a bend alignment enables the liquid crystal display device to respond to an inputted signal in very short time period compared with that observed by employing the other type liquid crystal display device.

### Fifth Embodiment

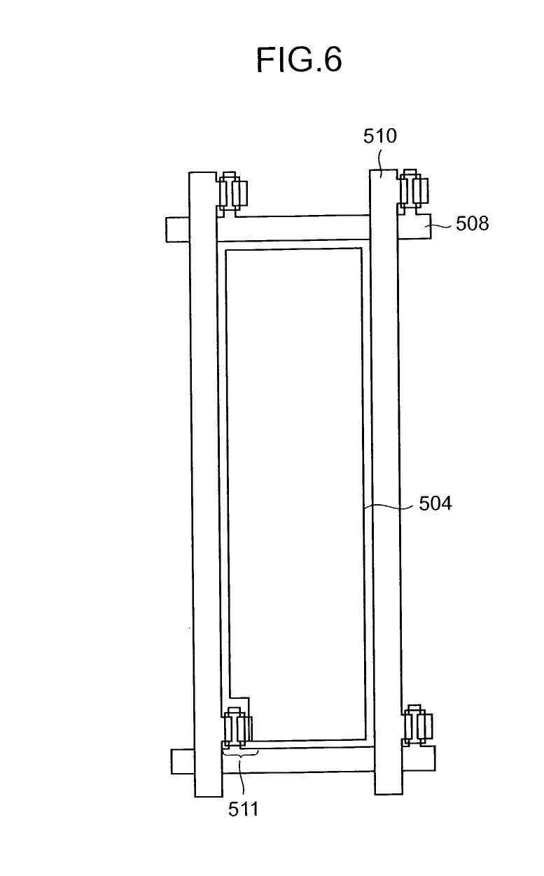

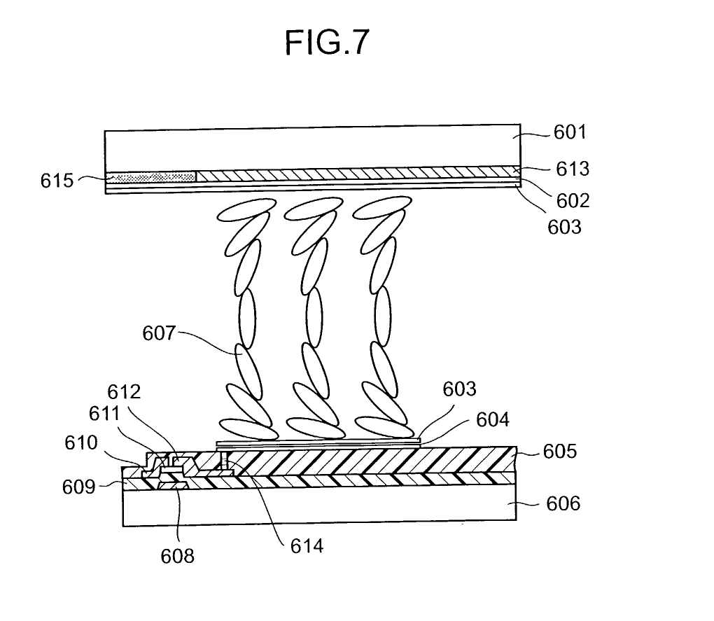

FIGS. 6 and 7 show a liquid crystal display device according to a fifth embodiment. FIG. 6 is a plan view of one pixel of a liquid crystal display device of the embodiment. FIG. 7 is a sectional view of the liquid crystal display device of the embodiment.

As shown in FIG. 6, in an active matrix liquid crystal display device of the embodiment, scanning signal electrodes 508 and video signal electrodes 510 which are intersected in matrix, a plurality of thin film transistors 511 formed at positions corresponding to respective intersection points of the scanning signal electrodes 508 and the video signal electrodes 510, and pixel electrodes 504 formed in respective regions surrounded by the scanning signal electrodes 508 and the video signal electrodes 510, are formed on a first substrate 606 (see FIG. 7).

As shown in FIG. 7, the active matrix liquid crystal display device of the embodiment is constructed such that on the first substrate 606 are formed: a scanning signal electrode (gate electrode) 608, a gate insulating film 609 formed on the first substrate 606 so as to cover the scanning signal electrode 608; a video signal electrode 610 (source electrode) and a drain electrode 612 which are formed on the gate insulating film 609; an insulating film 605 covering the video signal electrode 610, the drain electrode 612 and the gate insulating film 609; a pixel electrode 604 formed on the insulating film 605; and an alignment film 603 formed on the pixel electrode 604.

The pixel electrode 604 is connected with the drain electrode 612 through a contact hole 614 formed in the insulating film 605.

A thin film transistor 611 is composed of the scanning signal electrode (gate electrode) 608, the video signal electrode 610 (source electrode) and the drain electrode 612.

Furthermore, on a second substrate 601 are formed: a color filter 613; a light shielding film 615 formed on the same layer on which the color filter 613 is also formed; a common electrode 602 formed on the color filter 613 and the light shielding film 615; and an alignment film 603 formed on the common electrode 602.

A liquid crystal layer 607 is sandwiched between the first substrate 606 and the second substrate 601.

In the liquid crystal display device of the embodiment, the pixel electrode 604 is separated from the scanning signal electrode 608, the video signal electrode 610 and the thin film transistor 611 via the insulating film 605.

Note that polarizers, ¼ wavelength plates and birefringence compensation plates are omitted in FIG. 6 and FIG. 7 for simplicity.

In a general transmissive liquid crystal display device, the scanning signal electrode 508, the video signal electrode 510 and the thin film transistor 511 are formed on the same layer on which the pixel electrode 504 is formed. Accordingly, the orientation of the liquid crystal molecules located on the pixel electrode 504 is easily affected by the scanning signal electrode 508, the video signal electrode 510 and the thin film transistor 511, thereby likely degrading stability of a liquid crystal layer having a bend alignment.

On the contrary, the liquid crystal display devices of the first to fourth embodiments are different from the transmissive liquid crystal display device as follows. That is, in the liquid crystal display device of the embodiments, the state of the liquid crystal is switched by the thin film transistor 611 as an active element and on the first substrate 606, the pixel electrode 604 is separated from the scanning signal electrode 608, the video signal electrode 610 and the thin film transistor 611 by the insulating layer 605 to improve stability of the liquid crystal layer having a bend alignment.

The embodiments make it possible to enhance stability of a liquid crystal layer having a bend alignment during the time period in which a liquid crystal layer is being driven, enabling a liquid crystal display device to display images viewed from a wide viewing angle and responding in short time period.

Note that this embodiment can be applied to any one of the first to fourth embodiments described above.

It should also be understood that, in the case of a liquid crystal display device, in which pixels are divided into sub-pixels consisting of primary colors, one sub-pixel has a vertically elongated shape such that a ratio of a longitudinal length of pixel to a transversal length thereof is about 3:1 and therefore, taking into account the lateral fields from a gate electrode and a drain electrode, the aligning direction of liquid crystal molecules at interface between liquid crystal molecules and an alignment layer is advantageously made to coincide with a direction parallel to the short side of a pixel to improve stability of a liquid crystal layer having a bend alignment.

An alignment method employed in the embodiment is not limited to a widely used rubbing and may be realized by employing a light alignment technique.

Also, in order to further improve the stability of a liquid crystal layer having a bend alignment, an ultraviolet polymerization monomer such as a liquid crystalline diacrylate monomer may be added to the liquid crystal layer 607 and ultraviolet may be irradiated to the liquid crystal layer having a bend alignment to polymerize the ultraviolet polymerization monomer, thereby stabilizing the bend alignment.

### Sixth Embodiment

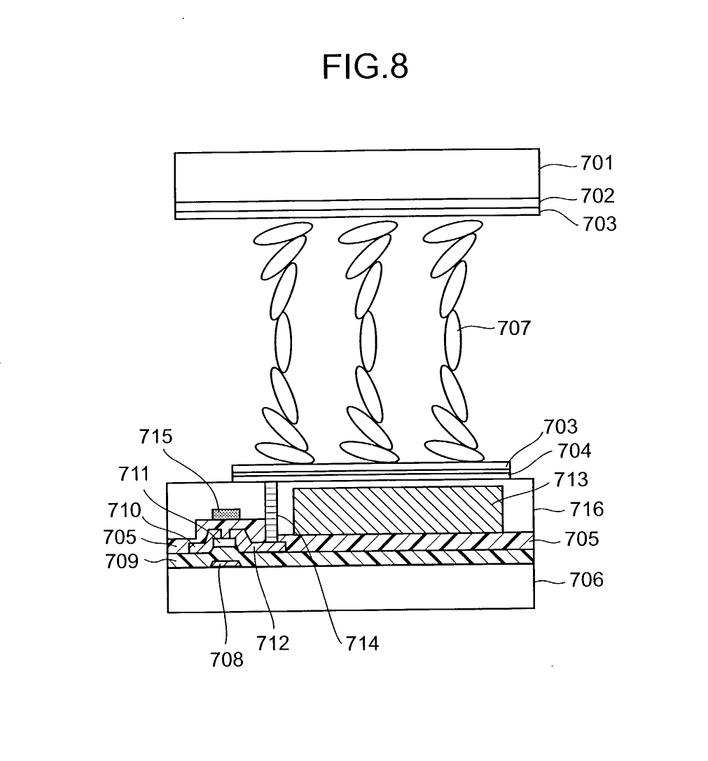

FIG. 8 is a sectional view of one pixel of a liquid crystal display device of a sixth embodiment.

As shown in FIG. 8, the liquid crystal display device of the embodiment is constructed such that on a first substrate 706 are formed: a scanning signal electrode (gate electrode) 708; a gate insulating film 709 formed on the first substrate 706 so as to cover the scanning signal electrode 708; a video signal electrode 710 (source electrode) and a drain electrode 712 which are formed on the gate insulating film 709; an insulating film 705 covering the video signal electrode 710, the drain electrode 712 and the gate insulating film 709; a color filter 713 formed on the insulating film 705; a light shielding film 715 formed on the insulating film 705, on which the color filter 713 is also formed, and above the scanning signal electrode 708; an overcoat film 716 formed on the insulating film 705 to cover the color filter 713 and the light shielding film 715; a pixel electrode 704 formed on the overcoat film 716; and an alignment film 703 formed on the pixel electrode 704.

The pixel electrode 704 is connected with the drain electrode 712 through a contact hole 714 formed in the overcoat film 716 and the insulating film 705.

A thin film transistor 711 is composed of the scanning signal electrode (gate electrode) 708, the video signal electrode 710 (source electrode) and the drain electrode 712.

On the second substrate 701 are formed a common electrode 702 and an alignment film 703 thereon.

A liquid crystal layer 707 is sandwiched between the first substrate 706 and the second substrate 701.

In the embodiment, on the first substrate 706 the pixel electrode 704 is separated from the scanning signal electrode 708, the video signal electrode 710 and the thin film transistor 711 by the color filter 713 to improve stability of a liquid crystal layer having a bend alignment, which construction is different from that of the fifth embodiment.

Although the fifth embodiment is constructed such that the color filter 613 is formed on the second substrate 601 having the common electrode 602 thereon, the embodiment is constructed so that the color filter 713 is formed on the first substrate 706, as shown in FIG. 8. The scanning signal electrode 708, the video signal electrode 710 and the thin film transistor 711 are covered by the insulating layer 705, and the light shielding film 715 and the color filter 713 are formed thereon. Furthermore, an entire surface of the first substrate 706 is covered by the overcoat film 716 and the pixel electrode 704 is formed thereon. The pixel electrode 704 is connected with the drain electrode 712 through the contact hole 714.

Note that polarizers, ¼ wavelength plates and birefringence compensation plates are omitted in FIG. 8 for simplicity.

The liquid crystal display device of the embodiment is constructed so that the pixel electrode 704 is separated from the scanning signal electrode 708, the video signal electrode 710 and the thin film transistor 711 via the insulating film 705 and the color filter 713, and in addition, can be manufactured by aligning the first and second substrates with each other without high accuracy, thereby advantageously producing allowance for manufacturing tolerances applicable to manufacture of a liquid crystal display device.

The liquid crystal display device of the embodiment makes it possible to enhance stability of a liquid crystal layer having a bend alignment during the time period in which a liquid crystal layer is being driven, enabling a liquid crystal display device to display images viewed from a wide viewing angle and responding in short time period.

Note that this embodiment can be applied to any one of the first to fourth embodiments described above.

It should also be understood that, in the case of a liquid crystal display device, in which pixels are divided into sub-pixels consisting of primary colors, one sub-pixel has a vertically elongated shape such that a ratio of a longitudinal length of pixel to a transversal length thereof is about 3:1 and therefore, taking into account the lateral fields from a gate electrode and a drain electrode, the aligning direction of liquid crystal molecules at interface between liquid crystal molecules and an alignment layer is advantageously made to coincide with a direction parallel to the short side of a pixel to improve stability of a liquid crystal layer having a bend alignment.

An alignment method employed in the embodiment is not limited to a widely used rubbing and may be realized by employing a light alignment technique.

Also, in order to further improve the stability of a liquid crystal layer having a bend alignment, an ultraviolet polymerization monomer such as a liquid crystalline diacrylate monomer may be added to the liquid crystal layer 707 and ultraviolet may be irradiated to the liquid crystal layer having a bend alignment to polymerize the ultraviolet polymerization monomer, thereby stabilizing the bend alignment.

Examples describing the above-stated embodiments in more detail will be explained below.

### EXAMPLE 1

An ITO film is formed on a glass substrate by sputtering and an ITO electrode is formed in matrix using a photolithography technique. Then, an alignment film is applied onto a first substrate and a second substrate and is sintered at 200° C. for 1 hour, and further, is subjected to rubbing treatment. A sealant is applied to the peripheral portions of the first and second substrates and the first and second substrates are bonded to each other such that rubbing directions for the first and second substrates are parallel to each other and the electrodes on the first and second substrates are arranged in matrix, that is, in an X-Y fashion, and then, the sealant is cured by heating.

A nematic liquid crystal having the birefringence An of 0.13 is injected between the substrates through an injection inlet and the injection inlet is sealed with a light curable resin. A set of a polarizer and a ¼ wavelength plate are bonded to each of the first and second substrates such that an angle between an optical axis of the ¼ wavelength plate and a transmission axis of the polarizer is made 45° relative to each other to make circularly polarized lights outputted respectively from the ¼ wavelength plate and the polarizer each have a polarity opposite each other.

A bias voltage is applied to the thus obtained liquid crystal panel to cause transition from a splay alignment to a bend alignment and an intensity of a light exiting therefrom is measured, and it was concluded that a maximum value of the intensity of the light is constant regardless of a direction of the transmission axis of the polarizer.

Also, owing to the liquid crystal layer having a bend alignment, the liquid crystal panel was able to clearly display images regardless of angles, from which the images are viewed, and particularly, when the images are viewed from the angles along the direction of the transmission axis of the polarizer.

In addition, even when a time period necessary for the molecules to respond to an on/off voltage applied thereto is added to a time period necessary for the molecules to convert the light inputted thereto, an entire time period necessary for the liquid crystal panel to respond to a supplied signal becomes at most 7 ms, enabling the liquid crystal panel to respond in very short time period.

### EXAMPLE 2

A liquid crystal panel is assembled in the same manner as that employed to fabricate the example 1. Two optical compensation plates made by a discotic liquid crystal that has negative birefringence are bonded respectively to the front and rear of the liquid crystal panel such that the retardation of both the optical compensation plates is equal to and has a sign opposite the retardation of a liquid crystal layer at 5 V as a black display voltage. After that, a set of a polarizer and a ¼ wavelength plate are bonded to each of the first and second substrates such that an angle between an optical axis of the ¼ wavelength plate and a transmission axis of the polarizer is made 45° relative to each other to make circularly polarized lights outputted respectively from the ¼ wavelength plate and the polarizer each have a polarity opposite each other.

A bias voltage is applied to the thus obtained liquid crystal panel to cause transition from a splay alignment to a bend alignment and viewing angle properties of the panel are measured, and it was concluded that the panel rarely exhibits scale inversion and is able to clearly display images having very wide area with high contrast therein.

It was also concluded that the transmission axis of the polarizer can be made in an arbitrary direction and the panel can respond to an inputted signal in very short time period.

### EXAMPLE 3

A liquid crystal panel is assembled in the same manner as that employed to fabricate the example 1. A single optical compensation plate made by a discotic liquid crystal that has negative birefringence is bonded to a face of the liquid crystal panel, from which a light exits, such that the retardation of the optical compensation plate is equal to and has a sign opposite the retardation of a liquid crystal layer at 5 V as a black display voltage. After that, a set of a polarizer and a ¼ wavelength plate are bonded to each of the first and second substrates such that an angle between an optical axis of the ¼ wavelength plate and a transmission axis of the polarizer is made 45° relative to each other to make circularly polarized lights outputted respectively from the ¼ wavelength plate and the polarizer each have a polarity opposite each other. In this case, one of the ¼ wavelength plates is made optically positive and the other is made optically negative. An arrangement of the ¼ wavelength plates makes the optical axes of the two ¼ wavelength plates become parallel to each other, enabling one of the two ¼ wavelength plates to compensate for the birefringence of the other.

A bias voltage is applied to the thus obtained liquid crystal panel to cause transition from a splay alignment to a bend alignment and viewing angle properties of the panel are measured, and it was concluded that the panel rarely exhibits scale inversion and is able to clearly display images having very wide area with high contrast therein.

It was also concluded that the transmission axis of the polarizer can be made in an arbitrary direction and the panel can respond to an inputted signal in very short time period.

### EXAMPLE 4

A liquid crystal panel is assembled in the same manner as that employed to fabricate the example 1. A single optical compensation plate made by a discotic liquid crystal that has positive birefringence is bonded to a face of the liquid crystal panel, from which a light exits, such that the retardation of the optical compensation plate is equal to and has a sign opposite the retardation of a liquid crystal layer at 2 V as a black display voltage, and further, an axis of the optical compensation plate, along which the refractive index thereof becomes maximum, is made orthogonal to the rubbing direction. After that, a set of a polarizer and a ¼ wavelength plate are bonded to each of the first and second substrates such that an angle between an optical axis of the ¼ wavelength plate and a transmission axis of the polarizer is made 45° relative to each other to make circularly polarized lights outputted respectively from the ¼ wavelength plate and the polarizer each have a polarity opposite each other. In this case, one of the ¼ wavelength plates is made optically positive and the other is made optically negative.

A bias voltage is applied to the thus obtained liquid crystal panel to cause transition from a splay alignment to a bend alignment and viewing angle properties of the panel are measured, and it was concluded that the panel rarely exhibits scale inversion and is able to clearly display images having very wide area with high contrast therein.

It was also concluded that the transmission axis of the polarizer can be made in an arbitrary direction and the panel can respond to an inputted signal in very short time period, i.e., 10 ms.

### EXAMPLE 5

Scanning signal electrodes are formed on a first substrate and a gate insulating film is formed thereon. Video signal electrodes intersecting the scanning signal electrodes in matrix and a plurality of thin film transistors at positions corresponding to respective intersection points are formed on the gate insulating film and covered by an insulating layer. Pixel electrodes are formed on the insulating layer at positions corresponding to respective regions surrounded by the scanning signal electrodes and the video signal electrodes and are connected with drain electrodes of the thin film transistors through contact holes.

A liquid crystal panel is assembled in the same manner as that employed to fabricate the example 1 by using a second substrate having a light shielding layer, a color filter and a common electrode thereon in addition to the thus manufactured first substrate. A rubbing direction is made parallel to the short side of each pixel.

Subjecting to the same manner as that employed to manufacture the example 3, a single optical compensation plate made by a discotic liquid crystal that has negative birefringence is bonded to a face of the liquid crystal panel, from which a light exits, such that the retardation of the optically negative birefringence compensation plate is equal to and has a sign opposite the retardation of a liquid crystal layer at a black display voltage. After that, a set of a polarizer and a ¼ wavelength plate are bonded to each of the first and second substrates such that an angle between an optical axis of the ¼ wavelength plate and a transmission axis of the polarizer is made 45° relative to each other to make-circularly polarized lights outputted respectively from the ¼ wavelength plate and the polarizer each have a polarity opposite each other.

A bias voltage is applied to the thus obtained liquid crystal panel to cause transition from a splay alignment to a bend alignment. Increase in the number of pixels having changed from a splay alignment to a bend alignment made sure that stability of bend alignment in the example is superior to that observed in the examples having a pixel electrode formed on the same layer on which a scanning signal electrode, an image signal electrode and a thin film transistor are formed.

It was also concluded that a maximum value of the intensity of the light exiting from the panel is constant regardless of a direction of the transmission axis of the polarizer.

Also, the liquid crystal panel was able to clearly display images regardless of angles, from which the images are viewed, and particularly, when the images are viewed from the angles along the direction of the transmission axis of the polarizer.

In addition, even when a time period necessary for the molecules to respond to an on/off voltage applied thereto is added to a time period necessary for the molecules to convert the light inputted thereto, an entire time period necessary for the liquid crystal panel to respond to a supplied signal becomes at most 7 ms, enabling the liquid crystal panel to respond in very short time period.

### EXAMPLE 6

Scanning signal electrodes are formed on a first substrate and a gate insulating film is formed thereon. Video signal electrodes which intersect the scanning signal electrodes in matrix and a plurality of thin film transistors at positions corresponding to respective intersection points are formed on the gate insulating film and are then covered by an insulating layer. A color filter and a light shielding film are formed on the insulating layer and then are further covered by an overcoat film. Pixel electrodes are formed on the overcoat film at positions corresponding to respective regions surrounded by the scanning signal electrodes and the video signal electrodes and connected with drain electrodes of the thin film transistors through contact holes.

A liquid crystal panel is assembled in the same manner as that employed to fabricate the example 1 by using the thus manufactured first substrate and a second substrate including a common electrode. A rubbing direction is made parallel to the short side of each pixel.

Subjecting to the same manner as that employed to manufacture the example 5, a single optical compensation plate made by a discotic liquid crystal that has negative birefringence is bonded to a face of the liquid crystal panel, from which a light exits, such that the retardation of the optically negative birefringence compensation plate is equal to and has a sign opposite the retardation of a liquid crystal layer at a black display voltage. After that, a set of a polarizer and a ¼ wavelength plate are bonded to each of the first and second substrates such that an angle between an optical axis of the ¼ wavelength plate and a transmission axis of the polarizer is made 45° relative to each other to make circularly polarized lights outputted respectively from the ¼ wavelength plate and the polarizer each have a polarity opposite each other.

A bias voltage is applied to the thus obtained liquid crystal panel to cause transition from a splay alignment to a bend alignment. Stability of bend alignment in the example is securely superior to that observed in the examples having a pixel electrode formed on the same layer on which a scanning signal electrode, an image signal electrode and a thin film transistor are formed.

It was also concluded that a maximum value of the intensity of the light exiting from the panel is constant regardless of a direction of the transmission axis of the polarizer.

Also, the liquid crystal panel was able to clearly display images regardless of angles, from which the images are viewed, and particularly, when the images are viewed from the angles along the direction of the transmission axis of the polarizer. In addition, a time period necessary for the liquid crystal panel to respond to a supplied signal became extremely short.

As described so far, in the liquid crystal display device constructed in accordance with the present invention, at least a geometric angle between the transmission axis of the polarizer and the optical axis of the ¼ wavelength plate is made keeping 45°, the orientation of the transmission axis of the polarizer may be made free regardless of the direction of the optical axis of the liquid crystal layer having a bend alignment. Thus, more desirable viewing angle properties are obtained as desired by a user without deteriorating optical symmetry and stability of a liquid crystal layer having a bend alignment.

For example, a viewing angle along horizontal and vertical directions can be increased to make images to be displayed on a display more natural.

Furthermore, since the liquid crystal display device constructed in accordance with the present invention utilizes the circularly polarized light, even when a rubbing angle is slightly shifted, an optical characteristic is never significantly deteriorated, thereby advantageously producing allowance for manufacturing tolerances applicable to manufacture of a liquid crystal display device.

What is claimed is:

1. A liquid crystal display device comprising:
a first substrate;
a second substrate;
a liquid crystal layer sandwiched between said first substrate and said second substrate and having a bend alignment;
a first ¼ wavelength plate disposed on a surface of said first substrate, said surface being positioned opposite said liquid crystal layer;
a second ¼ wavelength plate disposed on a surface of said second substrate, said surface being positioned opposite said liquid crystal layer;
at least one first polarizer disposed on a surface of said first ¼ wavelength plate, said surface being positioned opposite said liquid crystal layer; and
at least one second polarizer disposed on a surface of said second ¼ wavelength plate, said surface being positioned opposite said liquid crystal layer.

2. The liquid crystal display device according to claim 1, wherein said first ¼ wavelength plate is optically positive, said second ¼ wavelength plate is optically negative and said first ¼ wavelength plate and said second ¼ wavelength plate each are disposed so as to compensate for birefringence of the other.

3. The liquid crystal display device according to claim 1, wherein:
said first ¼ wavelength plate and said first polarizer are constructed such that circularly polarized lights outputted respectively from said first ¼ wavelength plate and said first polarizer are opposite each other;
said second ¼ wavelength plate and said second polarizer are constructed such that circularly polarized lights outputted respectively from said second ¼ wavelength plate and said second polarizer are opposite each other;
an angle between an optical axis of said first ¼ wavelength plate and a transmission axis of said first polarizer is made 45° relative to each other; and
an angle between an optical axis of said second ¼ wavelength plate and a transmission axis of said second polarizer is made 45° relative to each other.

4. The liquid crystal display device according to claim 1, further comprising:
a first birefringence compensation plate disposed between said first substrate and said first ¼ wavelength plate; and
a second birefringence compensation plate disposed between said second substrate and said second ¼ wavelength plate,
wherein both said first and second birefringence compensation plates each are comprised of optically negative elements and have a principal axis within a layer of each of said first and second birefringence compensation plates changing, and birefringence of said liquid crystal layer is compensated by said first and second birefringence compensation plates.

5. The liquid crystal display device according to claim 1, further comprising a birefringence compensation plate disposed between said second substrate and said second ¼ wavelength plate,
wherein said birefringence compensation plate is comprised of optically negative elements and have a principal axis within a layer of said birefringence compensation plate changing, and birefringence of said liquid crystal layer is compensated by said birefringence compensation plate.

6. The liquid crystal display device according to claim 1, further comprising one of an optically positive uniaxial birefringence compensation plate and an optically positive biaxial birefringence compensation plate disposed between said second substrate and said second ¼ wavelength plate,
wherein birefringence of said liquid crystal layer is compensated by corresponding one of said uniaxial birefringence compensation plate and said biaxial birefringence compensation plate.

7. The liquid crystal display device according to claim 1, wherein on said first substrate there are formed:
a plurality of scanning signal electrodes;
a plurality of video signal electrodes intersecting said scanning signal electrodes in matrix;
a plurality of thin film transistors formed at positions corresponding to respective intersection points of said scanning signal electrodes and said video signal electrodes,
a pixel having one of areas surrounded by said scanning signal electrodes and said video signal electrodes; and
a pixel electrode connected with each of said plurality of thin film transistors corresponding to said pixel,
wherein on said second substrate there is formed a common electrode for supplying a reference potential to a plurality of said pixels.

8. The liquid crystal display device according to claim 7, further comprising an interlayer insulating film formed on said first substrate for separating said pixel electrode from said scanning signal electrodes, said video signal electrodes and said thin film transistors.

9. The liquid crystal display device according to claim 7, further comprising a color filter layer formed on said first substrate and on said scanning signal electrodes, said video signal electrodes and said thin film transistors, wherein said the pixel electrode is separated from said scanning signal electrodes, said video signal electrodes and said thin film transistors via said color filter layer.

10. The liquid crystal display device according to claim 7, wherein said liquid crystal layer contains an ultraviolet polymerization monomer therein to stabilize said liquid crystal layer having a bend alignment.

11. The liquid crystal display device according to claim 10, wherein said ultraviolet polymerization monomer is a liquid crystalline diacrylate monomer.

12. The liquid crystal display device according to claim 7, wherein an orientation of said liquid crystal near interfaces between said first and second substrates and said liquid crystal layer is substantially parallel to a short side of said pixel.
